(19) United States
(12) Patent Application Publication
(10) Pub. No.: US 2021/0177206 A1
(43) Pub. Date: Jun. 17, 2021

(54) MODULAR SECONDARY COOKING SYSTEM

(71) Applicant: W.C. BRADLEY CO., Columbus, GA (US)

(72) Inventors: THOMAS H. WARD, CATAULA, GA (US); RYAN STERRITT, Opelika, AL (US); WESLEY J. WAGNER, Columbus, GA (US)

(21) Appl. No.: 17/107,227

(22) Filed: Nov. 30, 2020

Related U.S. Application Data
(60) Provisional application No. 62/942,586, filed on Dec. 2, 2019.

(51) Int. Cl. A47J 37/07

(52) U.S. Cl. CPC A47J 37/0786; A47J 2037/0795; A47J 2201/00

(57) ABSTRACT

A system includes a plurality of vertical elements installed in a cooking appliance and defining a plurality of installation locations having a vertical and horizontal position inside the cooking appliance, and a plurality of modular secondary cooking elements selectively installable in the plurality of locations.

### CROSS-REFERENCE TO RELATED CASES

This application claims the benefit of U.S. provisional patent application Ser. No. 62/942,586, filed on Dec. 2, 2019, and incorporates such provisional application by reference into this disclosure as if fully set out at this point.

### FIELD OF THE INVENTION

This disclosure relates to outdoor cooking systems in general and, more specifically, to secondary cooking apparatus for use in outdoor cooking systems.

### BACKGROUND OF THE INVENTION

Cooking grills may contain a primary grate or other cooking surface which is exposed to the highest temperatures used for cooking within the appliance. However, lower temperatures are sometimes useful, even when the primary grate is relatively hot. For example, simultaneous lower temperature cooking, warming, and the like may be desirable.

What is needed is a system and method for addressing the above and related issues.

### SUMMARY OF THE INVENTION

The invention of the present disclosure, in one aspect thereof, comprises a system including a plurality of vertical elements installed in a cooking appliance and defining a plurality of installation locations having a vertical and horizontal position inside the cooking appliance, and a plurality of modular secondary cooking elements selectively installable in the plurality of locations.

In some embodiments, the plurality of locations are superior to a main cooking grate inside the cooking appliance. Each of the plurality of locations may be defined by a pair of slots defined in adjacent ones of the plurality of vertical elements, each slot of the pair of slots having a vertical location in the grill matching the other.

In some cases, each slot is rectilinear having a width and a height. The width may be sufficient to accommodate two brackets from two adjacent ones of the plurality of modular secondary cooking elements. Each of the plurality of vertical elements may further comprises two spaced apart sidewalls joined to a front facing surface spaced apart from a back wall of the cooking appliance. In some embodiments, the slots are defined in the front facing surface.

The invention of the present disclosure, in another aspect thereof, comprises a system including two spaced apart vertical elements installed proximate a back wall of a cooking appliance and defining a plurality of pairs of slots at predetermined vertical locations, one slot of each pair being defined in one of the two spaced apart vertical elements. The system includes at least one modular secondary cooking element that is retained in any of the predetermined vertical locations by a pair of brackets retained by the respective slots at that location.

In some cases the system further comprises at least one additional spaced apart vertical element proximate the back wall of the cooking appliance and defining a plurality of slots, each at one of the predetermined vertical locations corresponding to each of the pairs of slots defined in the two spaced apart vertical elements. The system may comprise at least one additional modular secondary cooking element that is retained in any of the predetermined vertical locations by an additional pair of brackets retained by the respective slots at that location. The system may have an additional modular secondary cooking element having three hooks that are retained in three slots at one of the predetermined vertical locations.

According to some embodiments, each of the spaced apart vertical elements comprises a pair of spaced apart walls having a contour fitting to the back wall of the cooking appliance and supporting a front facing surface spaced apart from the back wall of the cooking appliance, the front facing surface defining the slots of the respective vertical element.

Each of the pair of brackets may comprise a hook that fits into the respective slot and a brace below the hook that abuts the front facing surface. The modular secondary cooking elements may further comprise a secondary cooking surface supported in a horizontal orientation by a pair of spaced apart arms joined to the pair of brackets.

The invention of the present disclosure, in another aspect thereof, comprises a kit for installation of a modular secondary cooking system into a cooking grill. The kit includes at least two vertical elements having a front facing surface defining a plurality of spaced apart apertures, and at least one secondary cooking element having a pair of brackets that insert into the spaced apart apertures of the at least two vertical elements. With the two vertical elements installed into the cooking grill adjacent a back wall thereof, the at least one secondary cooking element has an adjustable height of installation based upon which of pairs of apertures at a same vertical location on the vertical elements the pair of brackets is inserted into.

Some kits include at least one additional vertical element having a front facing surface defining a plurality of spaced apart apertures such that a plurality of horizontally adjacent mounting locations for the at least one secondary cooking element is provided.

In some cases, each of the at least two vertical elements comprise a pair of spaced apart upright walls securing the front facing surface. The pair of spaced apart upright walls of each of the at least two vertical elements may be contoured to conform to the back wall of the of the cooking grill.

The kit may have at least one additional secondary cooking element having a pair of brackets that insert into the spaced apart apertures of the at least two vertical elements. The at least one secondary cooking element may have a cooking surface with a differing configuration than a cooking surface of the at least one additional secondary cooking element.

### BRIEF DESCRIPTION OF THE DRAWINGS

FIG. 1 is a perspective interior view of a cooking appliance with modular secondary cooking system according to aspects of the present disclosure.

FIG. 2 is a perspective view of the modular secondary cooking system of FIG. 1.

FIG. 3 is a perspective view of another modular secondary cooking system according to aspects of the present disclosure.

FIG. 4 is another perspective view of the modular secondary cooking system of FIG. 3.

FIG. 5 is a close-up perspective view of the modular secondary cooking system of FIG. 3.

FIG. 6 is a close-up perspective view of a vertical element of a modular secondary cooking system according to the present disclosure.

FIG. 7 is a perspective view of a modular secondary cooking element according to aspects of the present disclosure.

### DETAILED DESCRIPTION OF THE PREFERRED EMBODIMENTS

Some known prior disclosures relating to secondary cooking include for example in US Patent Publication No. US 2017/0065124 and U.S. Pat. No. 5,694,917 both incorporated herein by reference. Another example of a pivoting type secondary cooking surface is seen in US Patent Publication No. US 2006/0137676, also incorporated by reference.

Limitations of prior art solutions include, but are not limited to, the fact that vertical adjustment of the secondary cooking surfaces is not possible, and the secondary cooking surface is unitary. Such secondary surfaces may consist of the same type of element as the primary grate over the full width of the product. Therefore, it is not possible to adjust the vertical height of different portions of such secondary surfaces to finely adjust the amount of heat. Additionally, such unitary secondary cooking surfaces do not allow different types of cooking to be done at the same time, as, for example, items that were cooked in a dish versus items cooked on a griddle-like surface.

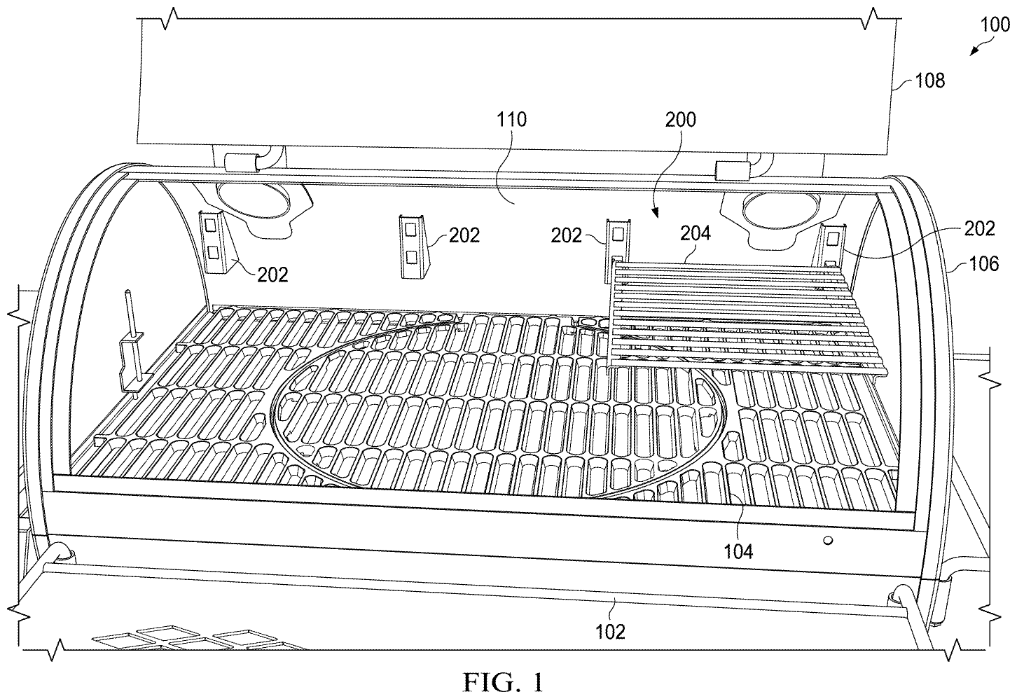

Referring now to FIG. 1, an outdoor cooking appliance, such as a barbecue grill 100 or similar, may comprise a lower body 102 containing a source of heat (e.g., a gas burner, pellet burner, or charcoal, not shown). A primary food support element or cooking grate 104 may be located above the heat source, possibly depending from, or support by, the lower body 102. An upper covering 106 may comprise a hood or lid 108 which is removable or openable to allow access inside the grill 100.

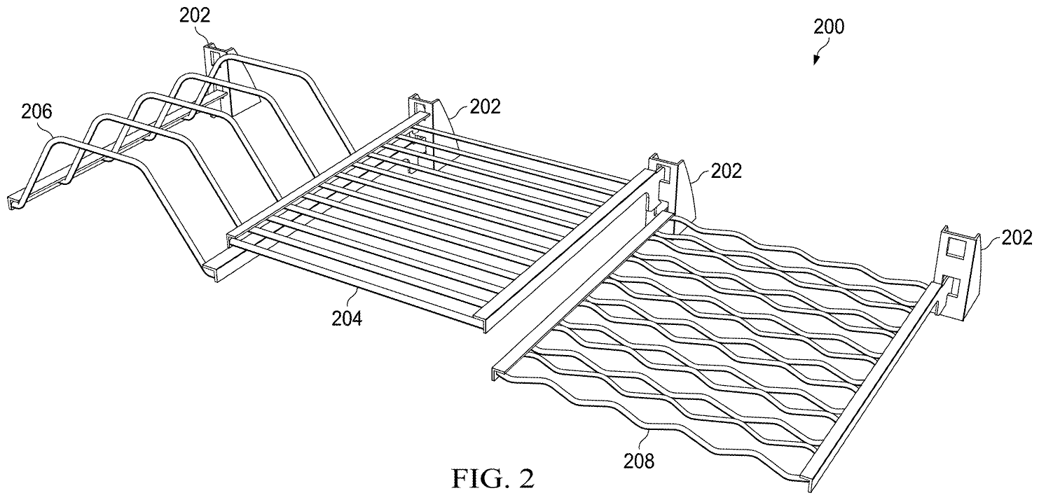

According to various embodiments disclosed herein, a modular system of adjustable secondary cooking surfaces of various types is provided. One example of a modular secondary cooking system 200 of the present disclosure is shown in FIGS. 1-2. A set of at least two vertical elements 202 are attached to an interior back wall 110 extending upwardly from the lower body 102 of the appliance 100. The back wall 110 may also be part of the upper covering 106. The vertical elements 202 are spaced apart a predetermined distance to support various interchangeable components to be mounted within the appliance 100 and provide secondary cooking mechanisms. Shown in FIG. 1 is a warming rack 204. The warming rack 204 may be adjusted both vertically and horizontally on the back wall 110 by attachment to different locations on the vertical elements 202.

The system 200 is shown removed from the appliance 100 in FIG. 2 for purposes of illustration. Here it can be seen that multiple modular cooking components may be selectively at various locations with respect to the vertical elements 202. As shown, there are four vertical elements 202 defining three (left, middle, right) horizontal location and two vertical locations. In the present example, a toast rack 206 is installed on the left location, a warming rack 204 is installed centrally, and a pepper rack 208 is installed on the right location. The toast rack 206 and pepper rack 208 are installed in lower vertical locations while the warming rack 204 is installed in a taller vertical location such that the components 104, 206, 208 may overlap where they attach to the vertical elements 202.

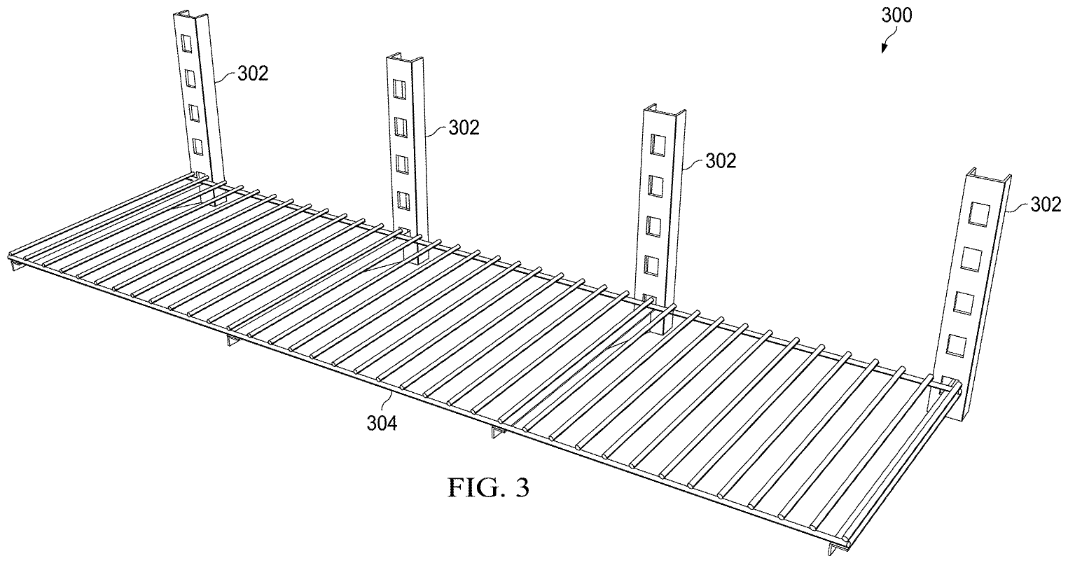

It should be understood that the toast rack 206, warming rack, 204, and pepper rack 208 are only examples of the modular secondary cooking elements, components, implements, etc. that may be used with systems of the present disclosure. Furthermore, their size may vary from that shown. In another example of a modular secondary cooking system shown in FIG. 3, the system 300 comprises a wide warming rack 304 that is sized to occupy the entire width of the device into which it is installed. Here also, vertical elements 302 provide a larger range of vertical adjustments than the vertical elements 202 of FIGS. 1-2. It is also possible to install additional modular elements above the warming rack 304 illustrated in FIG. 3.

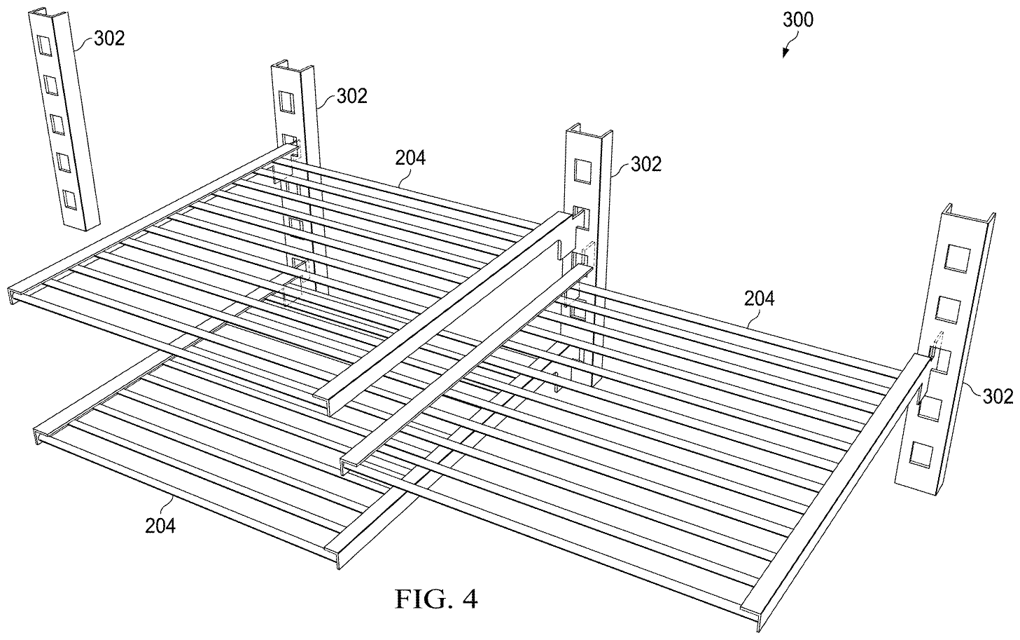

Reference to FIG. 4 illustrates the system 300 having three of the smaller warming racks 204 installed onto four of the taller vertical elements 302. Here, there are four vertical elements 302 providing three spaces (horizontally) for installation of modular components. The left most space is empty while two warming racks 204 are installed into the middle space. A single warming rack 204 is installed into the right most position. Number, spacing, and location of the modular elements or components is exemplary only, as one of skill in the art will readily adapt the number of locations of various modular elements to suit specific needs.

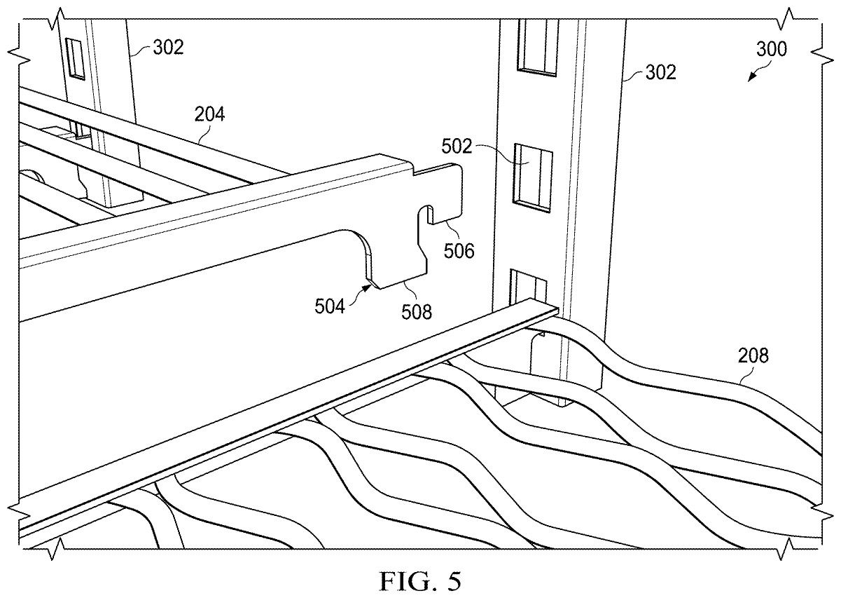

Referring now to FIG. 5, a close-up view of the system 300 is shown. Vertical elements 302 may be equipped with a series of slots or keyholes 502 at various vertical locations for receiving the modular components. Here, pepper rack 208 is shown installed into vertical element 302 while warming rack 204 is removed for illustration. A bracket 504 may be provided with a hook 506 and brace 508. The hook 506 is placed into the slot 502. The hook 506 anchors the warming rack 204 elevationally and the brace 508 maintains the warming rack in a level or other desired orientation. Other modular components may attach similarly. Other variations of adjustable attachment height vertical elements may be incorporated instead of, or in addition to, those illustrated.

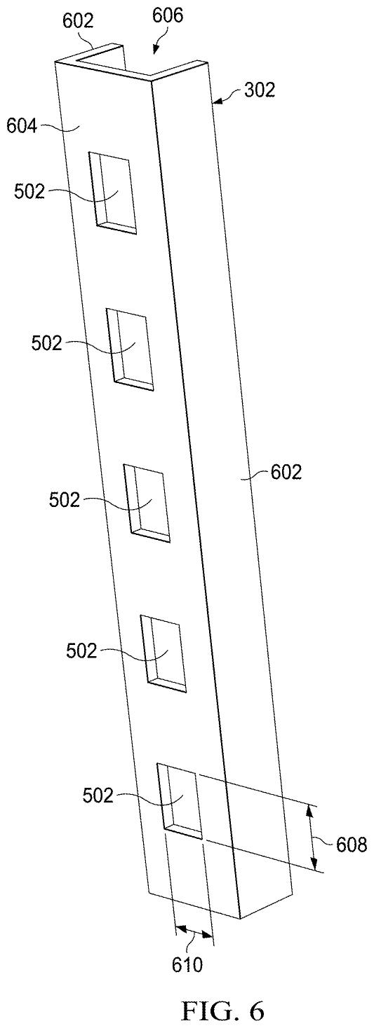

With further reference now to FIG. 6, a vertical element 302 is further illustrated. The vertical element 302 may comprise a pair of spaced apart upright walls 602. These walls 602 may be generally flat or planar and may be connected by a front facing surface 604. When modular cooking systems of the present disclosure are installed into a cooking appliance, the front facing surface 602 may be spaced apart from, for example, the back wall 110 by the walls 602. The walls 602 are illustrated as having a rectangular shape but they may be curved to accommodate a curved back wall (as can be seen in FIG. 1, 110 for example) while presenting the front facing surface 602 in an upright position to receive modular cooking components in a level configuration.

The walls 602 can be seen to define a channel 606 behind the front facing wall 604 into which hooks 506 (FIG. 5) are situated when modular components such as warming racks 204 and others are attached. The front facing wall 604 defines the slots or keyholes 502 therein. In the case of the vertical element 302, there are four keyholes 502 spaced apart vertically along the front facing wall. In the case of other vertical elements, such as vertical element 202 there may only be two keyholes defined. Of course, the present disclosure is not limited to the number of keyholes or vertical locations that modular components may be attached to. Nor is it strictly necessary that each vertical element of a modular system provide the same number of keyholes or slots.

Slots 502 may have a square, rectangular, or other appearance. In some embodiments, each slot has a width 610 and a height 608. The width 610 may be sufficient to accommodate two modular elements side by side, or may only be wide enough to accommodate a single modular element. The heights 608 may be made to accommodate the attachment of a modular component (by receiving hook 506, for example). Spacing between slots 502 may also vary. In some embodiments, spacing between slots 502 is tall enough to accommodate brace 508 while leaving sufficient clearance below the specific slot 502 so as not to interfere with installation and removal of modular elements below.

The vertical elements of the present disclosure (e.g., 202, 302) may be installed into a cooking appliance by being affixed to the back wall 110 or other location. Vertical elements 202, 302 may be installed by fasteners, by welding, or by other mechanisms.

In some embodiment, the modular cooking systems of the present disclosure (e.g., 200, 300) may be installed at the time of manufacture of the cooking appliance 100 or similar product. In other embodiments, the modular cooking systems 200, 300 may be sold as a kit and installed by a consumer or another after the initial sale of the cooking appliance 100.

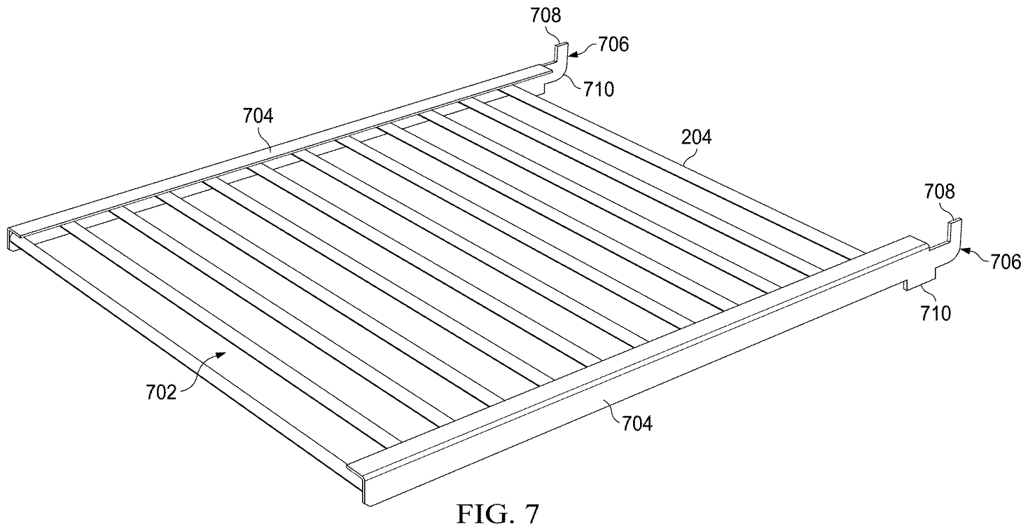

Referring now to FIG. 7 a perspective view of a modular secondary cooking element of the present disclosure is shown in greater detail. The illustrated secondary cooking element is a warming rack 204. In various embodiments, the secondary cooking elements may comprise a cooking surface 702. The cooking surface 702 may comprise a grate similar to that shown, or may comprise other specifically shaped and configured food supports specific to the type or warming or secondary cooking desired. The secondary cooking element could be configured as a pepper rack or toast rack as previously shown, for example.

The cooking surface 702 maybe supported by and/or affixed to a pair of spaced apart arms 704 having brackets 706 for fitting to the vertical elements 302 previously described or others. The brackets 706 may comprise a hook 708 for insertion into a slot and possibly a lower brace that abuts the vertical element (e.g., 302) when the secondary cooking element 204 is installed. The hooks 708 are upward facing hooks that connect with an upper portion of the aperture or slot (e.g., 502). This is in contrast to the hooks 506 of FIG. 5 that are downward facing for latching onto a lower portion of the aperture or slot 502. In either case, the cooking surface 702 may be held level or substantially so by the combination of the hook 506/708 and brace 508/710. In some embodiments, a level position of the cooking surface 702 is perpendicular to the front facing wall 502 of the vertical element 302.

According to the present disclosure, the ability to stagger the various modular secondary cooking surfaces vertically at varying distances from the heat source, combined with the ability to use various types of secondary cooking surfaces produces a larger range of choices to the user as to what is being cooked and how. It is also possible to remove all secondary cooking surfaces or modular components from a first side of a grill 100 (e.g., left or right) while retaining such surfaces on a second side so as to allow cooking a large food item on the first side where the said surfaces are removed and having such surfaces available on the second side to cook a variety of complimentary food items.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26 -100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

The term “selective” or “selectively,” unless otherwise indicated, is taken to mean that the operation or function is capable of being performed by the structure or device in reference, but the operation or function may not occur continuously or without interruption. Furthermore, a selective or selectively performed operation may be one that the user or operator of a device or method may choose whether or when to perform, but the function or operation is nevertheless fully operative on or within the relevant device, machine, or method and the same includes the necessary structure or components to perform such operation.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system comprising:
a plurality of vertical elements installed in a cooking appliance and defining a plurality of installation locations having a vertical and horizontal position inside the cooking appliance; and
a plurality of modular secondary cooking elements selectively installable in the plurality of locations.

2. The system of claim 1, wherein the plurality of locations are superior to a main cooking grate inside the cooking appliance.

3. The system of claim 2, wherein each of the plurality of locations is defined by a pair of slots defined in adjacent ones of the plurality of vertical elements, each slot of the pair of slots having a vertical location in the grill matching the other.

4. The system of claim 3, wherein each slot is rectilinear having a width and a height.

5. The system of claim 4, wherein the width is sufficient to accommodate two brackets from two adjacent ones of the plurality of modular secondary cooking elements.

6. The system of claim 5, wherein each of the plurality of vertical elements further comprises two spaced apart sidewalls joined to a front facing surface spaced apart from a back wall of the cooking appliance.

7. The system of claim 6, wherein the slots are defined in the front facing surface.

8. A system comprising:
two spaced apart vertical elements installed proximate a back wall of a cooking appliance and defining a plurality of pairs of slots at predetermined vertical locations, one slot of each pair being defined in one of the two spaced apart vertical elements; and
at least one modular secondary cooking element that is retained in any of the predetermined vertical locations by a pair of brackets retained by the respective slots at that location.

9. The system of claim 8, further comprising at least one additional spaced apart vertical element proximate the back wall of the cooking appliance and defining a plurality of slots, each at one of the predetermined vertical locations corresponding to each of the pairs of slots defined in the two spaced apart vertical elements.

10. The system of claim 9, further comprising at least one additional modular secondary cooking element that is retained in any of the predetermined vertical locations by an additional pair of brackets retained by the respective slots at that location.

11. The system of claim 9, further comprising an additional modular secondary cooking element having three hooks that are retained in three slots at one of the predetermined vertical locations.

12. The system of claim 8, wherein each of the spaced apart vertical elements comprises a pair of spaced apart walls having a contour fitting to the back wall of the cooking appliance and supporting a front facing surface spaced apart from the back wall of the cooking appliance, the front facing surface defining the slots of the respective vertical element.

13. The system of claim 12, wherein each of the pair of brackets comprises a hook that fits into the respective slot and a brace below the hook that abuts the front facing surface.

14. The system of claim 8, wherein the modular secondary cooking element further comprises a secondary cooking surface supported in a horizontal orientation by a pair of spaced apart arms joined to the pair of brackets.

15. A kit for installation of a modular secondary cooking system into a cooking grill comprising:
at least two vertical elements having a front facing surface defining a plurality of spaced apart apertures; and
at least one secondary cooking element having a pair of brackets that insert into the spaced apart apertures of the at least two vertical elements;
wherein, with the two vertical elements installed into the cooking grill adjacent a back wall thereof, the at least one secondary cooking element has an adjustable height of installation based upon which of pairs of apertures at a same vertical location on the vertical elements the pair of brackets is inserted into.

16. The kit of claim 15, further comprising at least one additional vertical element having a front facing surface defining a plurality of spaced apart apertures such that a plurality of horizontally adjacent mounting locations for the at least one secondary cooking element is provided.

17. The kit of claim 15, wherein each of the at least two vertical elements comprise a pair of spaced apart upright walls securing the front facing surface.

18. The kit of claim 17, wherein the pair of spaced apart upright walls of each of the at least two vertical elements are contoured to conform to the back wall of the of the cooking grill.

19. The kit of claim 15, further comprising at least one additional secondary cooking element having a pair of brackets that insert into the spaced apart apertures of the at least two vertical elements.

20. The kit of claim, wherein the at least one secondary cooking element has a cooking surface with a differing configuration than a cooking surface of the at least one additional secondary cooking element.
